(19) United States
(12) Patent Application Publication
(10) Pub. No.: US 2008/0082752 A1
(43) Pub. Date: Apr. 3, 2008

(54) Method and apparatus for saving power for a computing system by providing instant-on resuming from a hibernation state

(76) Inventors: Ram Chary, Portland, OR (US); Shreekant S. Thakkar, Portland, OR (US); Ulf R. Hanebutte, Gig Harbor, WA (US); Pradeep Sebestian, Beaverton, OR (US); Shubha Kumbadakone, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/540,374

(22) Filed: Sep. 29, 2006

(51) Int. Cl. G06F 12/00

(52) U.S. Cl. 711/118

(57) ABSTRACT

A computing system may conserve more power by entering S4 state than S3 state over long periods of inactivity and also have an instant-on capability when assuming from S4 state by using a fast accessible non-volatile cache (e.g., flash memory). Rather than storing memory content to a disk drive, the memory content may be cached in the non-volatile cache when the system is entering S4 state. The non-volatile cache may be coupled to a bus that connects the disk drive with the disk controller. When resuming from S4 state, the memory content may be read from the non-volatile cache rather than from the slow disk drive. Both the caching and resuming processes may be performed in an OS-transparent manner. A mapping table may be created and stored in the non-volatile cache during the caching process to provide efficient reading from the non-volatile cache during the resuming process.

### RELATED APPLICATION

This application is related to commonly assigned U.S. application Ser. No. ______ (Attorney Docket No. 42P24468), concurrently filed by Ram Chary and Pradeep Sebastian and entitled “Configuring a Device for Operation on a Computing Platform,” and is related to commonly assigned U.S. application Ser. No. ______ (Attorney Docket No. 42P24527), concurrently filed by Ulf R. Hanebutte, Ram Chary, Pradeep Sebastian, Shubha Kumbadakone, and Shreekant S. Thakkar and entitled “Method and Apparatus for Caching Memory Content on a Computing System to Facilitate Instant-On Resuming from a Hibernation State.”

### BACKGROUND

1. Field

This disclosure relates generally to power consumption reduction in a computer system, and more specifically but not exclusively, to methods and apparatus for providing fast resuming from a hibernation state for low power computing platforms.

2. Description

Ultra mobility is becoming a trend for today's personal computers (PCs). Users expect many PCs, especially laptop PCs, to have all-day battery life and quick responding capability. To extend battery life, a PC needs to be aggressively put into low power idle states, much more aggressively than most PCs currently are. Today most PCs use Advanced Configuration and Power Interface (ACPI) to manage their power consumption. The ACPI enables an operating system (OS) to control the amount of power consumed by a PC. With the ACPI, the OS can put a PC into the S4 (hibernate) state or the S3 (sleep) state when the PC is not active for a certain period of time. A PC consumes much more power under the S3 state than under the S4 states. Thus, to extend battery life and hence to become more mobile, it is desirable to put a PC into the S4 state over long periods of inactivity. However, while the S4 state is ideal for conserving power, it is a high-latency sleep state since the system context is saved to (and read back on resume from) the hard disk drive (HDD). Given that the hand-top PCs normally need to use micro-drives (to achieve the form-factor & cost targets), this results in resume times varying widely from 3-4 seconds (S3 resume) to 30 plus seconds (S4 resume using micro-drives). In other words, while the S4 state conserves more power than the S3 state, it slows down a PC's responding time during wakeup, which becomes less acceptable in today's fast-pace computing environment. Thus, it is desirable to reduce S4 resume time.

### BRIEF DESCRIPTION OF THE DRAWINGS

The features and advantages of the disclosed subject matter will become apparent from the following detailed description of the subject matter in which:

FIG. 1 shows one example computing system where the ACPI may be used for power management and the hibernation resume time may be reduced;

FIGS. 2A and 2B illustrate how hibernate data is stored when a computing system enters a hibernation state and how the hibernate is read when the system resumes from the hibernation state;

FIGS. 3A and 3B illustrate how hibernate data is stored when a PC enters a hibernation state and how the hibernate data is read when the PC resumes from the hibernation state, using a non-volatile cache;

FIG. 4 shows a block diagram of a computing system where a non-volatile cache may be used to store/read from the hibernate data when the system enters/resumes from a hibernation state;

FIG. 5 is a flowchart of an example process for caching hibernate data in a non-volatile cache when a computing system enters a hibernation state;

FIG. 6 is a flowchart of an example process for reading hibernate data from a non-volatile cache back to main memory when a computing system resumes from a hibernation state;

FIG. 7 illustrates an example mapping table stored/read from a non-volatile cache when a computing system enters/resumes from a hibernation state;

FIG. 8 is a flowchart of an example process for reading hibernate data from a non-volatile cache in the path of resuming from a hibernation state; and

FIG. 9 is pseudo code illustrating an example process for reading hibernate data from a non-volatile cache in the path of resuming from a hibernation state.

### DETAILED DESCRIPTION

According to embodiments of the subject matter disclosed in this application, a computing system may conserve most power by entering the S4 state (rather than the S3 state) over long periods of inactivity and also be able to resume from the S4 state rapidly to provide a quick response. Rather than storing hibernate data in the HDD, a non-volatile cache may be used to cache the hibernate data when the system enters the S4 state. The non-volatile cache may be made of flash memory and may be coupled to a bus that connects the HDD with the disk controller. When resuming from the S4 state, the hibernate data may be read from the non-volatile cache and hence resume time may be reduced because access latency to the non-volatile cache is much shorter than to the HDD. Both the caching and resuming processes may be performed in an OS-transparent manner (e.g., by storage driver and Option Read-Only-Memory (ROM)). The resume time may be further reduced by using an efficient resuming process which relies on a mapping table to help search desired data in the non-volatile cache. Additionally, the non-volatile cache may also be used as a disk cache to improve Input/Output (I/O) performance and to reduce power consumption.

Reference in the specification to “one embodiment” or “an embodiment” of the disclosed subject matter means that a particular feature, structure or characteristic described in connection with the embodiment is included in at least one embodiment of the disclosed subject matter. Thus, the appearances of the phrase “in one embodiment” appearing in various places throughout the specification are not necessarily all referring to the same embodiment.

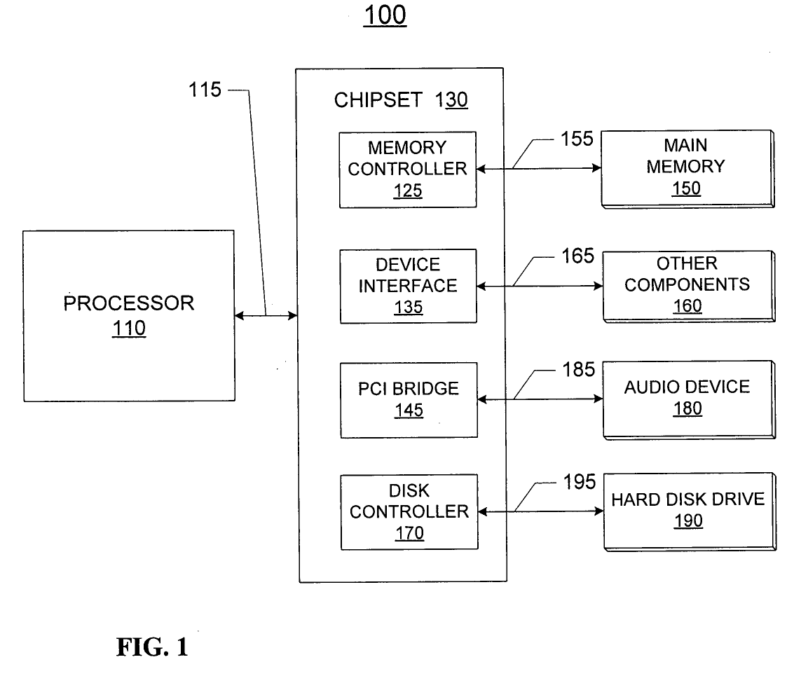

FIG. 1 shows one example computing system 100 where the ACPI may be used for power management and the S4 resume time may be reduced. Computing system 100 may comprise one or more processors 110 coupled to a system interconnect 115. Processor 110 may have multiple or many processing cores (for brevity of description, term “multiple cores” will be used hereinafter to include both multiple processing cores and many processing cores). The computing system 100 may also include a chipset 130 coupled to the system interconnect 115. Chipset 130 may include one or more integrated circuit packages or chips. Chipset 130 may comprise one or more device interfaces 135 to support data transfers to and/or from other components 160 of the computing system 100 such as, for example, keyboards, mice, network interfaces, etc. The device interface 135 may be coupled with other components 160 through a bus 165. Chipset 130 may be coupled to a Peripheral Component Interconnect (PCI) bus 185. Chipset 130 may include a PCI bridge 145 that provides an interface to the PCI bus 185. The PCI Bridge 145 may provide a data path between the processor 110 as well as other components 160, and peripheral devices such as, for example, an audio device 180. Although not shown, other devices may also be coupled to the PCI bus 185.

Additionally, chipset 130 may comprise a memory controller 125 that is coupled to a main memory 150 through a memory bus 155. The main memory 150 may store data and sequences of instructions that are executed by multiple cores of the processor 110 or any other device included in the system. The memory controller 125 may access the main memory 150 in response to memory transactions associated with multiple cores of the processor 110, and other devices in the computing system 100. In one embodiment, memory controller 125 may be located in processor 110 or some other circuitries. The main memory 150 may comprise various memory devices that provide addressable storage locations which the memory controller 125 may read data from and/or write data to. The main memory 150 may comprise one or more different types of memory devices such as Dynamic Random Access Memory (DRAM) devices, Synchronous DRAM (SDRAM) devices, Double Data Rate (DDR) SDRAM devices, or other memory devices.

Moreover, chipset 130 may include a disk controller 170 coupled to a hard disk drive (HDD) 190 (or other disk drives not shown in the figure) through a bus 195. The disk controller allows processor 110 to communicate with the HDD 190. In some embodiments, disk controller 170 may be integrated into a disk drive (e.g., HDD 190). There may be different types of buses coupling disk controller 170 and HDD 190, for example, the advanced technology attachment (ATA) bus and PCI Express (PCI-E) bus.

An OS (not shown in the figure) may run in processor 110 to control the operations of the computing system 100. The OS may use the ACPI for managing power consumption by different components in the system. Under the ACPI, there are 4 sleep states S1 through S4. The time needed to bring the system back into normal wakeup working state (wake-latency time) is shortest for S1, short for S2 and S3, and not so short for S4. S1 is the most power-hungry of sleep modes with processor(s) and Random Access Memory (RAM) powered on. S2 is a deeper sleep state than S1, where the processor is powered off. The most common sleep states are S3 and S4. In S3 state, main memory (RAM) 150 is still powered and the user can quickly resume work exactly where he/she left off—the main memory content when the computer comes back from S3 is the same as when it was put into S3. S4 is the hibernation state, under which content of main memory 150 is saved to HDD 190, preserving the state of the operating system, all applications, open documents etc. The system may be put into either S3 (sleep) state or S4 (hibernation) state manually or automatically after a certain period of inactivity.

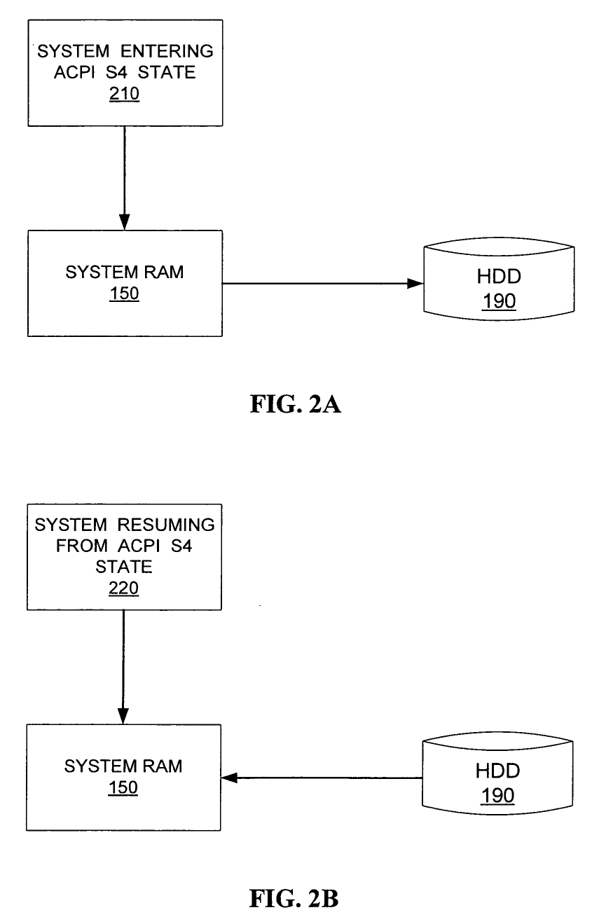

FIG. 2A illustrates the process of caching the main memory content to a hard drive when computing system 100 in FIG. 1 enters S4 state. When the system 100 enters into S4 state at block 210, the OS directs that a memory image (also called hibernate data or hiberfile) for memory 150 be generated. Once the memory image is generated, it is written to HDD 190. FIG. 2A illustrates the process for system 100 to resume from S4 state. When system 100 resumes from S4 state, the OS directs that all data necessary for the system to return where it left off be read from HDD 190 to memory 150. When resuming from S4 state, the sequence of memory data to be read may be different from the sequence of data cached to the HDD when the system enters S4 state.

Since the main memory is not powered on in S4 state, a system can save more power in S4 state than in S3 state. However, the resume time is much longer from S4 state than from S3 state since the main memory content needs to be read from a hard drive. When a micro-drive is used, the resume time from S4 state can even be longer than the resume time with a typical HDD. For an ultra mobile PC, it is desirable to have the instant-on resuming capability while still saving as much power as possible (and thus extend battery life). Therefore, it is desirable to reduce the resume time from S4 state for an ultra mobile PC. According to one embodiment of the subject matter disclosed in this application, a non-volatile cache (NV cache) may be used to cache the main memory content. For example, a NV cache (not shown in FIG. 1) may be added and coupled to disk controller 170 to cache content in memory 150 when system 100 enters S4 state. When system 100 wakes up from S4 state, the cached memory content may be read from the NV cache. Because access latency to the NV cache is much shorter than access latency to HDD 150, system 100 may achieve the instant-on goal when resuming from S4 state with the NV cache.

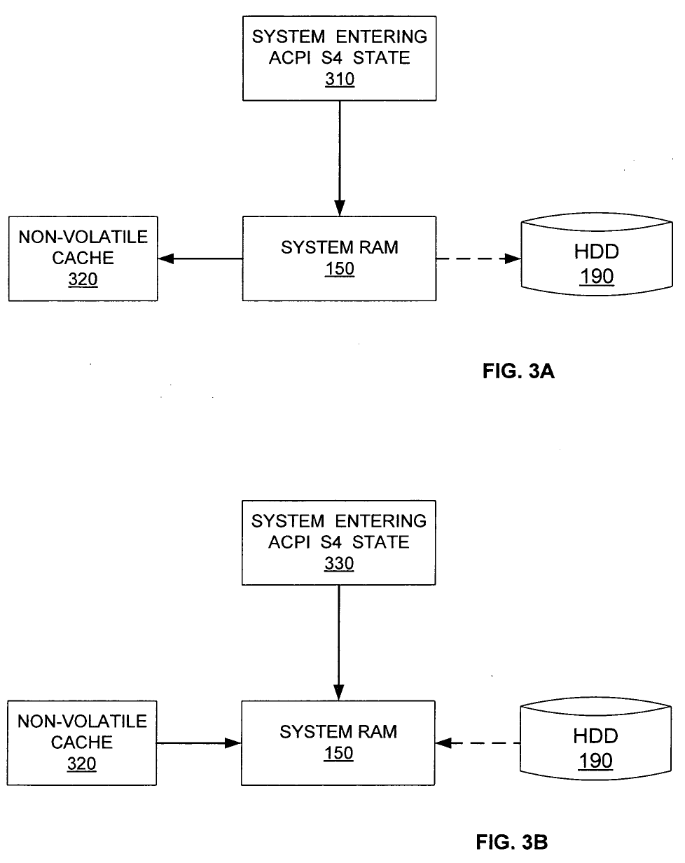

FIGS. 3A and 3B illustrate how memory content is stored when system 100 in FIG. 1 enters the S4 state and how the memory content is read when the system resumes from the S4 state, using a NV cache, as compared with FIGS. 2A and 2B, respectively, where no NV cache is used. In FIG. 3A, when system 100 enters S4 state at block 310, the OS directs that an image data for memory 150 be generated and written to HDD 190. However, requests to write the memory image to HDD are intercepted and the memory image is directed to NV cache 320. In FIG. 3B, when system 100 resumes from S4 state at block 330, the OS requests that the cached memory data be read back to memory 150 from HDD 190. However, the read requests may be intercepted and the cached memory data may actually be read from the NV cache 320.

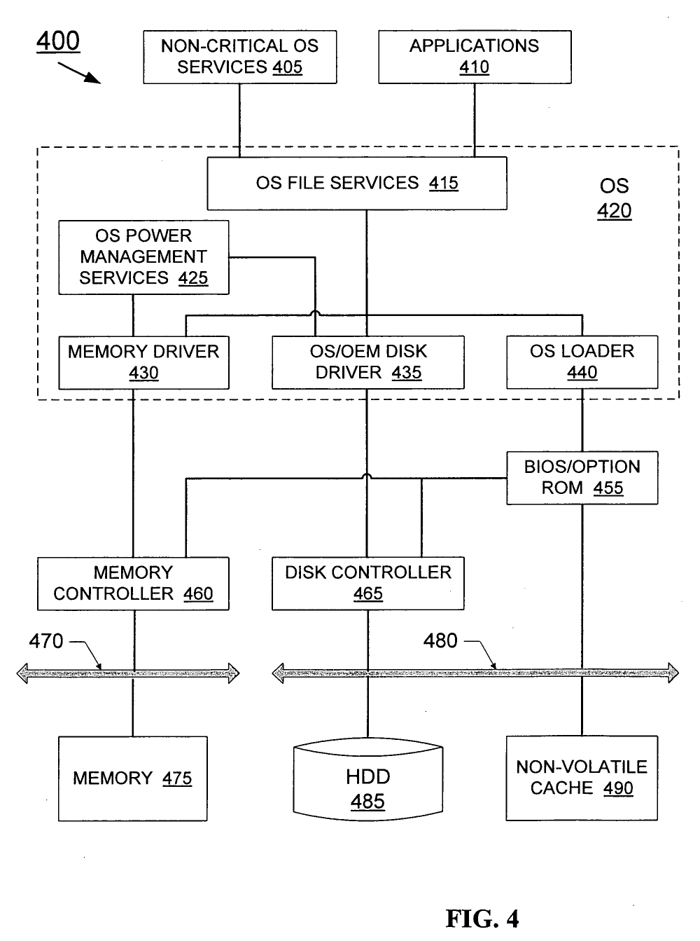

FIG. 4 shows a block diagram of a computing system 400 where a non-volatile cache may be used to cache the hibernate data when the system enters S4 state and to read from the hibernate data when the system resumes from the S4 state. System 400 may comprise an application layer, an OS layer, a controller layer, and a hardware layer. The application layer may include non-critical OS services 405 (e.g., data backup) and applications 410 (e.g., MP3 player). The OS layer mainly includes an OS 320 which may comprise several components such as OS file services 415, OS power management services 425, memory driver 430, an OS/OEM (Original Equipment Manufacturer) disk driver 435, and an OS loader 440. The controller layer may comprise a memory controller 460 and a disk controller 465. The hardware layer may include a memory 475, an HDD 485, and an NV cache 490, as well as memory bus 470 and disk bus 480. There may also be a firmware layer which may include basic I/O system (BIOS) and Option ROM 455. Note that these layers are used for the convenience of description and dividing lines between layers may vary.

OS file services 415 provide services to non-critical OS services 405 and applications. For example, OS file services 405 handle non-critical writes for non-critical OS services 405; and facilitate data prefetches for periodic applications. Components in the application lawyer such as non-critical OS services 405 and applications 410 do not directly deal with components in the controller layer and the hardware layer, but through OS components. For example, an application reads from or writes to memory 475 through memory driver 430; and reads from or writes to HDD 485 through OS/OEM disk driver. OS power management services 425 may use the ACPI to manage power consumption by different components in system 400. For example, when the OS puts the system into S4 hibernation state, power management services 425 request that an image be generated for content in memory 475, and the image be written to HDD 485. After completing writing the image to the HDD, the power management services 425 turn off power of memory 475 and other hardware components in the hardware layer. OS power management services 425 communicate with the memory and the HDD through the memory driver and the OS/OEM disk driver, respectively.

Memory driver 430 and OS/OEM disk driver 435 serve as interfaces between the OS and the controller layer, and facilitate any communication between the OS and memory 475 and HDD 485, respectively. When booting or resuming from a hibernation state, the BIOS boot service loads the first 512 bytes of the storage media. The first 512 bytes usually will include the OS first level boot loader that loads the OS second level loader (shown as OS loader 440 in FIG. 4). The OS second level loader (440) will decide if the system has to be resumed from S4 or booted from S5 (ACPI OFF state). The OS second level loader works with BIOS/Option Rom 455 to decide what needs to be run before a system can be up and running or before a system can return what it left off when it resumes from S4 state.

Memory controller 460 and disk controller 465 serve as hardware side interfaces to the OS for memory 475 and HDD 485, respectively. The memory controller and the disk controller are typically located within a chipset. In some computing systems, however, there might not be a chipset and the hardware side memory and disk controllers may reside within relevant chips that communicate between the OS and memory and HDD using appropriate software drivers. BIOS/Option ROM 455 helps determine what a system can do before the OS, is up and running. The BIOS includes firmware codes required to control basic peripherals such as keyboard, mouse, display screen, disk drive, serial communications, etc. The BIOS is typically standardized, especially for PCs. To customize some functions controlled by the BIOS, Option ROM may be used, which may be considered as an extension of BIOS to support OEM (Original Equipment Manufacturer) specific proprietary functionalities. When a system is booting up or resuming from S4 state, the BIOS calls code stored in the Option ROM. Thus, if a user desires a system to boot up differently from a standard booting process, the user may write his/her own booting code and store it in the Option ROM. The Option Rom may also include proprietary code to access memory controller 460 and disk controller 465.

According to one embodiment of the subject matter disclosed in this application, an NV cache 490 may be added to system 400. The NV cache may be coupled to disk bus 480 and be used to cache memory content when the system enters S4 state. The NV cache may be made of flash memory. When the system resumes from S4 state, the memory content (or hiberfile) can be restored from the NV cache rather than the HDD. Because the access latency to the NV cache is much shorter than the access latency to the HDD, restoring the memory content from the NV cache can significantly reduce the resuming time and thus provide instant-on or near instant-on experience for the user. Additionally, the NV cache may also be used as a disk cache in a normal wakeup working state. As a disk cache, the NV cache may help improve system I/O performance and reduce average system power consumption since the disk can be spun down for longer periods of time. Moreover, the subject matter disclosed herein may be extended to utilize the NV cache (such as flash memory) as a fast storage device for OS and applications combined with a slower storage device for data.

In one embodiment, caching and restoring the memory content using the NV cache may be performed entirely by the OS. In another embodiment, this can be done in an OS transparent manner. For example, caching the memory content in the NV cache may be done by the storage driver (e.g., OS/OEM disk driver 435); and restoring the memory content from the NV cache may be done by code in the Option ROM. Although OS/OEM disk driver 435 is shown in FIG. 4 as part of the OS, this driver may be replaced with OEM's own driver without interfering with any OS functionality. When caching and restoring the memory content using the NV cache is performed in an OS transparent manner, the NV cache may need to be placed on certain type of bus. For example, the OS may only write the hiberfile to a boot-drive which is typically on a specific bus (e.g., ATA bus). Also the OS may shut off secondary buses (e.g., PCI-E bus) prior to the stage when it caches the hiberfile. With the NV cache, a system may save considerable power by entering S4 states over long periods of inactivity while still having close to “instant on” capability desired for an ultra mobile computer.

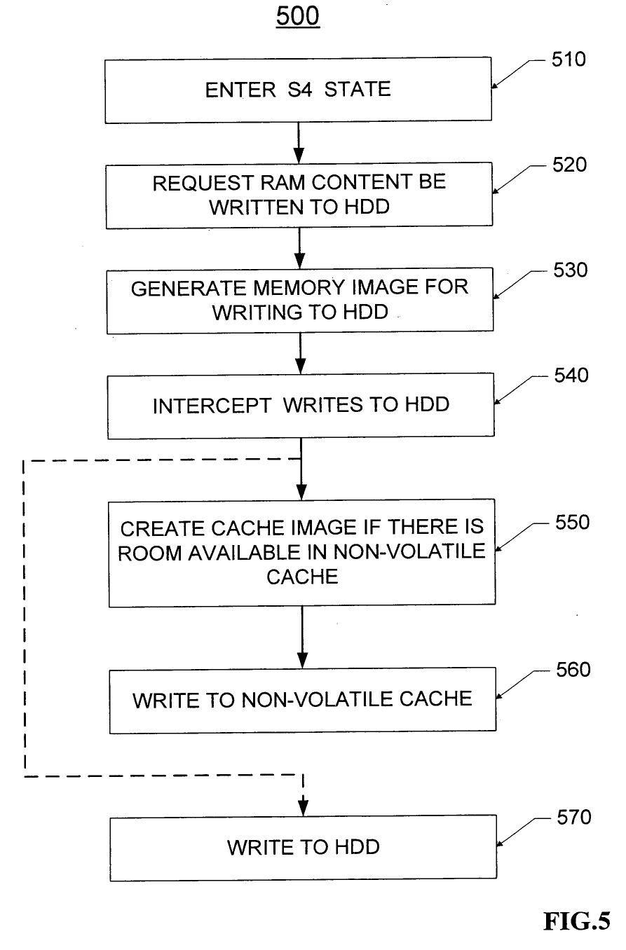

FIG. 5 is a flowchart of an example process 500 for caching memory content in a non-volatile cache when a computing system enters S4 state. At block 510, a computing system is entering S4 state. At block 520, a request is made that memory (RAM) content be written to HDD. At block 530, content image for the main memory (hiberfile) may be generated and is ready to be written to the HDD. Without the NV cache and corresponding changes to the system, the hiberfile will be directly written to the HDD. With the NV cache, writes to the HDD are intercepted at block 540. Typically any read from or write to the HDD is in the form of a SCSI Request Block (SRB), which include metadata and actual data that is to be read from or written to the HDD. Among other information, metadata includes the logical block address (LBA) of the actual data block on the HDD and the size of the data block in sectors.

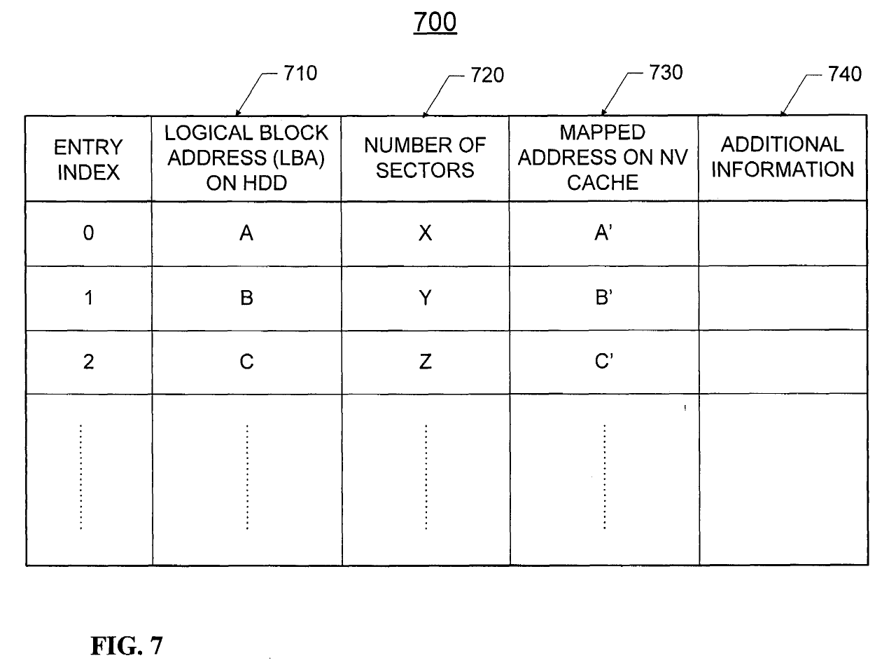

At block 550, a cache image may be created for a data block in each write if there is enough room available in the NV cache for the data block. At block 560, the cache image may be written to the NV cache. The cache image of a block of data to be written to the NV cache may still be in the form of an SRB, but metadata of the SRB needs to include the LBA of the block of data on the NV cache. Additionally, information specific to reads/writes to/from the HDD may be removed from the cache image. A mapping table, which correlates LBAs of data blocks on the HDD and the addressed of the same data blocks on the NV cache, may also be created while writing blocks of data to the NV cache. After completing writing the memory image to the NV cache or when the NV cache is full, the mapping table may be written to the NV cache. FIG. 7 illustrates an example of the mapping table. In one embodiment, the memory content may also be written to the HDD at the same time it is written to the NV cache. Writing to the NV cache and writing to the HDD may be performed in parallel so that there is no performance penalty by also writing the memory content to the HDD. In another embodiment, writing the memory content to the HDD may only be performed when there is no enough room available in the NV cache for the cache image.

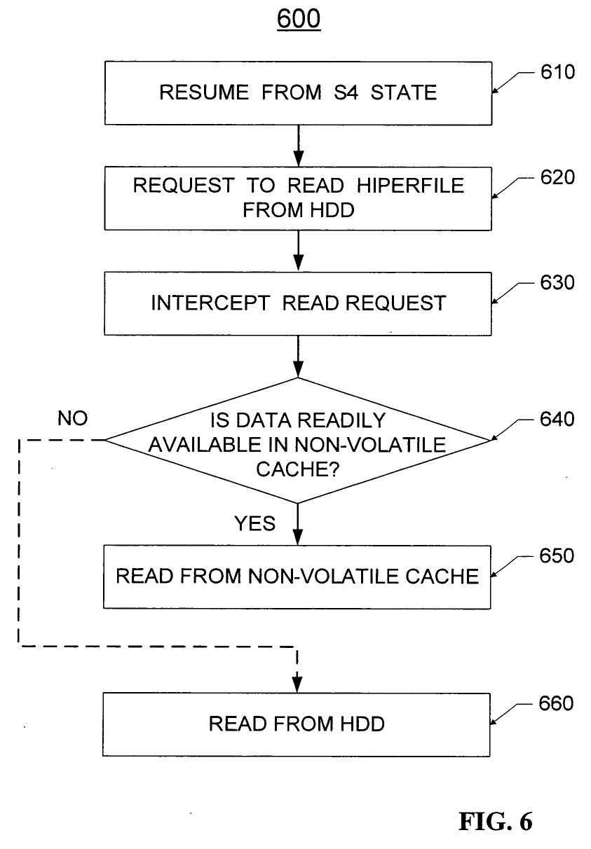

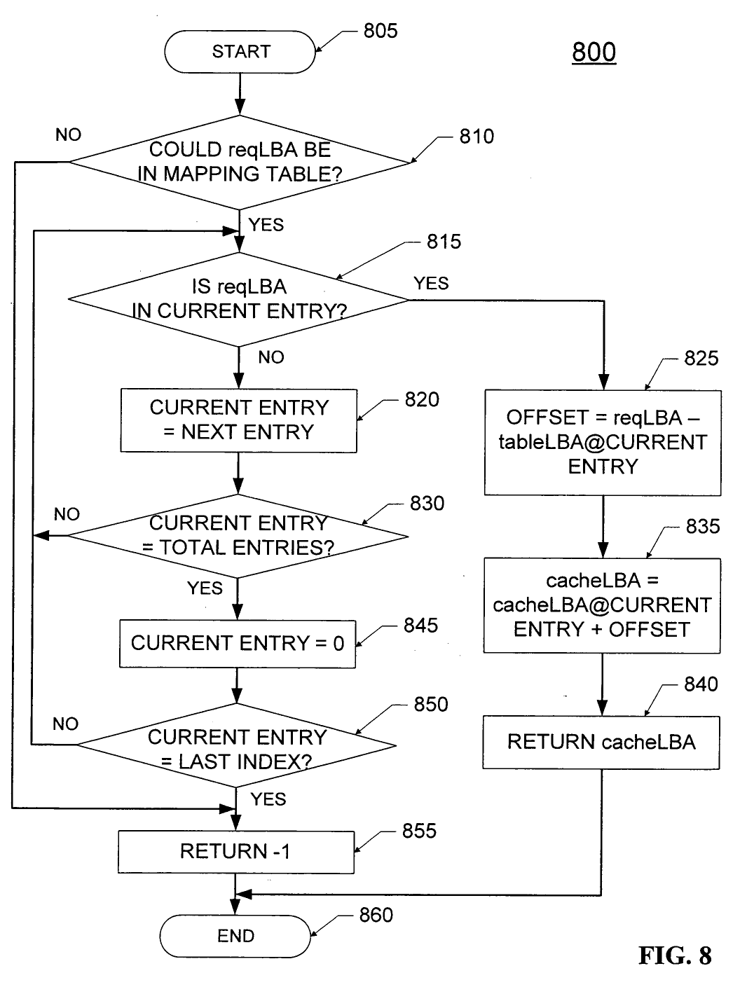

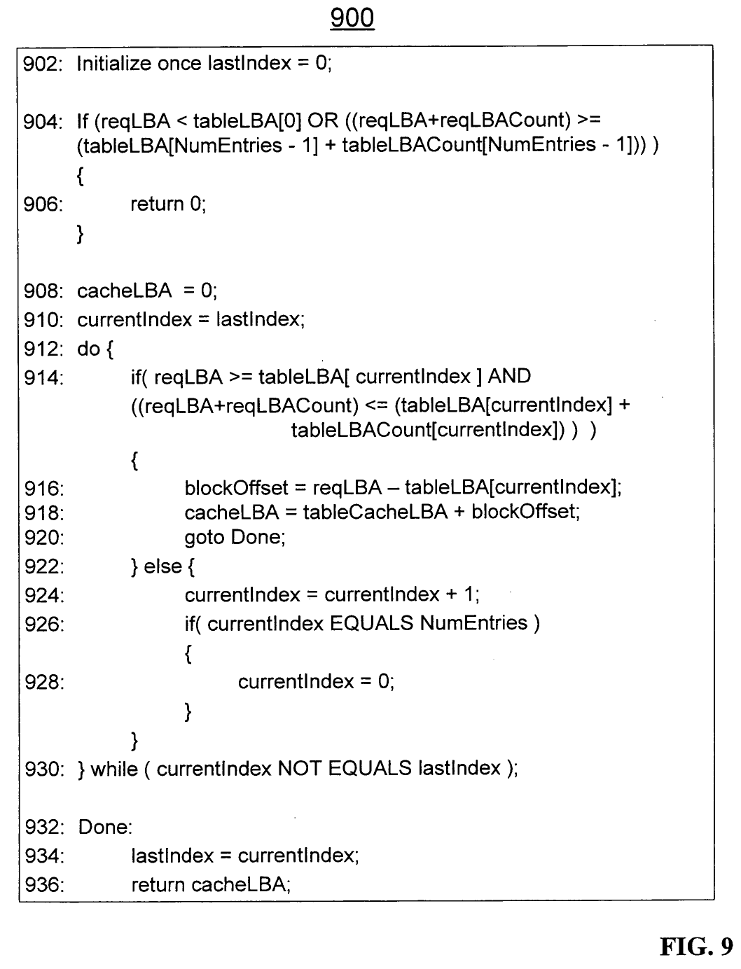

FIG. 6 is a flowchart of an example process 600 for reading the hibernate data from a NV cache back to main memory when a computing system resumes from the S4 state. At block 610, the system is resuming from S4 state. At block 620, a request to read memory data from HDD back to main memory may be made by the OS. At block 630, the read request may be intercepted and may be serviced by code in the Option ROM, which may redirect the read request to the NV cache rather than the HDD. At block 640, the code in the Option ROM may determine whether data requested is readily available in the NV cache. If the data requested is readily available in the NV cache, the data requested will be furnished by the NV cache at block 650; otherwise, the data requested will be furnished by the HDD at block 660. A specific example of the resuming process with more details is illustrated in FIGS. 8 and 9 and their corresponding descriptions.

FIG. 7 illustrates an example mapping table stored/read from a non-volatile cache when a computing system enters/resumes from S4 state. When the OS requests to cache memory content when a system is entering S4 state, the OS thought that the memory content will be written to the HDD, with various pieces of data written to different addresses in the HDD. Also when the OS requests the cached memory content be read back to main memory, it thought that the memory content will be read from the HDD and hence each read request includes an address in the HDD and the size of data requested. Because memory content is actually stored in and read from the NV cache, it is desirable to have a table that maps data addresses in HDD, which are known by the OS, to their corresponding addresses in the NV cache.

Logical block addressing (LBA) is a common scheme used for specifying the location of blocks of data stored on computer storage devices, generally secondary storage systems such as hard disks. The term LBA can mean either the address or the block to which it refers. Since LBA was first developed around SCSI (Small Computer System Interface) drives, LBA is often mentioned along with SCSI Request Block (SRB). Under the LBA scheme, blocks on disk are simply located by an index, with the first block being LBA=0, the second LBA=1, and so on. Most modern computers, especially PCs, support the LBA scheme. When an OS sends a data request (either a write or a read request) to HDD, the request typically includes LBA—the logical start address of the data block on the HDD, and the sector count—size of the data block on the disk. Typically in storage disk terms, a sector is also considered a logical block. For convenience of description, a data block is considered as a sequence of contiguous sectors in this application.

Turning back to FIG. 7, mapping table 700 illustrated therein comprises at least three columns: 710, 720, and 730. Column 710 includes LBAs of blocks on HDD and column 730 includes mapped addresses on the NV cache for the LBAs shown in column 710. Column 720 includes number of sectors (or size of blocks with LBAs on HDD shown in column 710). Column 740 shows some additional information which may be included in mapping table 700. Note that there may be multiple additional columns included in the table for other information. Mapping table 700 also includes a few examples showing the relationship between a LBA in column 710, its corresponding block size in column 720, and the LBA's mapped address on the NV cache in column 730. For example, block 1's LBA on HDD may be A; block 1 has X number of sectors; and its address on the NV cache is A′. A row in the mapping table is an entry and entries in the mapping table may be sorted by either LBAs on HDD, mapped addresses on NV cache or number of sectors. Entries in the mapping table may be indexed (as illustrated in table 700) for ease of search. The mapping table is constructed when the system is entering S4 state (before power to main memory is turned off).

For the following description, several notations are used for the convenience. Specifically, reqLBA is the logical start address of a data block that is requested to be read; reqLBACount indicates the number of sectors that are to be read starting from the reqLBA; and cacheLBA is the actual logical start address of the requested data block in the NV cache. tableLBA[i] is the logical start address of a data block in a mapping table entry; tableLBACount[i] is the count of sectors in the table entry; tableCacheLBA[i] is the logical start address of the mapped data block in the table entry; where i is the index of the entry in the table. Basically, tableLBA[i], tableLBACount[i], and tableCacheLBA[i] correspond to values in columns 710, 720, and 730 for entry i, respectively.

FIG. 8 is a flowchart of an example process 800 for reading hibernate data from a non-volatile cache in the path of resuming from the S4 state. Process 800 may be considered as a specific embodiment as compared to process 600 as shown in FIG. 6. Process 800 starts at block 805. At block 810, a check may be preformed to determine whether a reqLBA could be available in the mapping table. Rather than searching through the entire mapping table, a quick check may be conducted by comparing the reqLBA to the first and last entry in the mapping table. Entries in the mapping table may be sorted in ascending order of LBAs such that the smallest numbered LBA is at the first entry and the largest numbered LBA is at the last entry of the table. If the reqLBA is out of bounds of the mapping table, a value of −1 may be returned at block 855, which indicates that the requested block by the OS is not in the NV cache; the process may end at block 860; and the requested block may be read from HDD.

When process 800 starts at block 805, a current entry index is initialized with the index of the first entry (i.e., 0) in the mapping table if the reqLBA is the very first one; and with the index of the entry at which the process had stopped searching for the previous reqLBA if the reqLBA is not the very first one. If the reqLBA is determined to be within the bounds of the mapping table at block 810, a further check may be performed to determine if the request is really available in the mapping table by checking whether the reqLBA is available within the current entry in the mapping table at block 815. This further check may be conducted in a circular linear manner. This check may start searching from the entry at which it had stopped searching for the previous reqLBA. After the last entry in the table is reached, the search wraps around to the first entry and continues till the entry before the entry at which it had stopped searching for the previous reqLBA.

For a reqLBA to be present within a table entry, the reqLBA should be greater than or equal to the current table entry's start address of data block; and the (reqLBA+reqLBACount) should be less than or equal to the table entry's start address of data block plus table entry's data block size in sectors. The purpose of the check at block 815 is not to see if only a part of the reqLBA is available within a table entry. During the caching process, all data blocks that have contiguous LBAs are merged and shown in only one entry in the mapping table. Also when a system resumes from S4 state, most of data blocks requested typically have a contiguous LBA. Thus, if only a part of the reqLBA is available within a table entry, the requested block is split, i.e., part of it is on the NV cache and part of it is on the HDD. In a case of splitting data block, partially serving it from NV cache and from disk is more costly than serving this request from the disk since it requires multiple requests and a merge prior to providing the data block to the OS. Therefore, the entire block started with the reqLBA should be available within a table entry for the reqLBA to be considered to be present in the table.

If the reqLBA is not in the current entry, the current entry index may be set with the index of the next entry in the mapping table at block 820. Block 830 determines whether the last entry in the mapping table has been checked for the reqLBA. Whether the last entry has just been checked may be determined by whether the current entry index equals to the total number of entries. If the current entry index equals to the total number of entries in the mapping table, the last entry has just been checked. Then the current entry index may be reset to the index of the first entry in the mapping table at block 845. If the last entry has not been checked yet, the next entry in the mapping table is checked for the reqLBA at block 815. Block 850 determines whether the current entry index equals the last index, which is the index of the entry at which the process had stopped searching for the previous reqLBA. If the answer is “no,” the next entry in the mapping table is checked for the reqLBA at block 815; otherwise, a value of −1 may be returned at block 855, which indicates that the reqLBA is not present in the mapping table, and the process may end at block 860.

Once the reqLBA is found in the current entry at block 815, then the start address of the reqLBA in the NV cache, i.e., cacheLBA, is calculated by adding the offset of the reqLBA from the tableLBA[i] to the tableCacheLBA[i] where i is the index of the current table entry at block 835. Note that the start address of the requested data block and its size in sectors may not always match the start address of a data block in a table entry and its size. The start address of the requested data block may be at an offset (in sectors) from the start address of a data block in a table entry, which may be calculated at block 825. The cacheLBA of the reqLBA may be returned at block 840, and the process may end at block 860. If the reqLBA is not found in the mapping table, the requested data block may be read from disk rather than from the NV cache.

FIG. 9 is pseudo code 900 illustrating an example process for reading hibernate data from a non-volatile cache in the path of resuming from the S4 state. Pseudo code 900 illustrates a process similar to process 800 shown in FIG. 8 and is self-explaining.

Although an example embodiment of the disclosed subject matter is described with reference to block and flow diagrams in FIGS. 1-9, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method for caching memory content in a non-volatile cache when a computing system is entering a low power state, comprising:
requesting the memory content to be written to a non-volatile storage device;
generating an image for the memory content, the memory image to be written to the non-volatile storage device;
intercepting writes of the memory image to the non-volatile storage device; and
directing the writes to the non-volatile cache.

2. The method of claim 1, wherein the low power state comprises a hibernation state, the hibernation state including an S4 state under the Advanced Configuration and Power Interface (ACPI) specification.

3. The method of claim 1, wherein the non-volatile storage device comprises a hard disk drive.

4. The method of claim 1, further comprising:
determining if there is enough room available in the non-volatile cache for a data block included in each of the writes; and
if there is enough room available in the non-volatile cache, creating a cache image for the data block; and
writing the cache image to the non-volatile cache.

5. The method of claim 4, wherein the cache image comprises a mapping table having at least one entry each for a block of data, each entry including:
start logical block address (“LBA”) of the data block on the non-volatile storage device (“disk LBA”);
size of the data block in sectors (“data size”); and
mapped address on the non-volatile cache for the disk LBA (“cache LBA”).

6. The method of claim 1, wherein the non-volatile cache comprises flash memory.

7. The method of claim 1, further comprising writing the image to the non-volatile storage device.

8. A method for a computing system to resume from a low power state, the method comprising:
requesting memory data to be read from a non-volatile storage device;
directing the read request to a non-volatile cache; and
if the memory data is readily available, reading the memory data from the non-volatile cache.

9. The method of claim 8, wherein the non-volatile cache caches memory content while the computing system was entering the low power state.

10. The method of claim 8, wherein the low power state comprises a hibernation state, the hibernation state including an S4 state under the Advanced Configuration and Power Interface (ACPI) specification.

11. The method of claim 8, wherein the non-volatile storage device comprises a hard disk drive.

12. The method of claim 8, wherein the non-volatile cache comprises flash memory.

13. The method of claim 8, further comprising reading the memory data from the non-volatile storage device if the memory data is not readily available in the non-volatile cache.

14. The method of claim 13, wherein the memory data is not readily available in the non-volatile cache if the memory data is not entirely in the non-volatile cache.

15. A method for reading memory data from a non-volatile cache when a computing system resumes from a low power state, comprising:
requesting a block of memory data to be read from a non-volatile storage device, the requested data block having a start logical block address (LBA) on the non-volatile storage device (“reqLBA”);
directing the read request to the non-volatile cache, the non-volatile cache having a mapping table;
determining whether the reqLBA could be in the mapping table;
if the reqLBA could be in the mapping table, determining whether the requested data block is present in the non-volatile cache based on the reqLBA and information in the mapping table; and
if the requested data block is present in the non-volatile cache, reading the requested data block from the non-volatile cache.

16. The method of claim 15, wherein the low power state comprises a hibernation state, the hibernation state including an S4 state under the Advanced Configuration and Power Interface (ACPI) specification.

17. The method of claim 15, wherein the non-volatile storage device comprises a hard disk drive; and the non-volatile cache comprises flash memory.

18. The method of claim 15, wherein the mapping table comprises at least one entry each for a block of data, each entry including:
start logical block address (LBA) of the block of data on the non-volatile storage device (“disk LBA”);
size of the block of data in sectors (“data size”); and
mapped address on the non-volatile cache for the disk LBA (“cache LBA”).

19. The method of claim 18, wherein the mapping table is sorted by disk LBAs of the plurality of entries in at least one of ascend or decent order.

20. The method of claim 19, wherein determining whether the reqLBA could be in the mapping table comprises checking whether the reqLBA is within bounds of the mapping table by comparing the reqLBA with disk LBAs in the first and the last entries in the mapping table.

21. The method of claim 20, wherein determining whether the requested data block is present in the non-volatile cache comprises determining whether the reqLBA is in an entry of the mapping table, wherein the requested data block is considered to be present in the non-volatile cache if the reqLBA is in an entry of the mapping table.

22. The method of claim 21, wherein determining whether the reqLBA is in an entry of the mapping table comprises using a circular linear search scheme.

23. The method of claim 15, wherein reading the requested data block from the non-volatile cache further comprises obtaining a cache LBA for the requested data block based on the reqLBA and information in the mapping table.

24. The method of claim 15, further comprising reading the requested data block from the non-volatile storage device if the reqLBA could not be in the mapping table or if the requested data block is not present in the non-volatile cache.

25. A computing system for providing instant-on resume from a low power state, comprising:
a processor;
a main memory coupled to the processor;
a non-volatile storage device coupled to the processor and the main memory; and
a non-volatile cache to cache content in the main memory that is to be written to the non-volatile storage device when the computing system is entering the low power state, and to provide data requested from the non-volatile storage device for the main memory when the computing system resumes from the low power state;
wherein the processor and the main memory are turned off power after the computing system has entered the low power state.

26. The system of claim 25, wherein access latency to the non-volatile cache is shorter than access latency to the non-volatile storage device.

27. The system of claim 25, wherein the low power state comprises a hibernation state, the hibernation state including an S4 state under the Advanced Configuration and Power Interface (ACPI) specification.

28. The system of claim 25, wherein the non-volatile storage device comprises a hard disk drive; and the non-volatile cache comprises flash memory.

29. The system of claim 25, further comprising a non-volatile storage device driver to redirect writes to the non-volatile storage device to the non-volatile cache if there is enough room available in the non-volatile cache, when the computing system is entering the low power state; the non-volatile storage device driver including a hardware disk driver.

30. The system of claim 29, wherein power for the main memory is not turned off until all required content in the main memory has been written to at least one of the non-volatile storage device or the non-volatile cache.

31. The system of claim 25, wherein the non-volatile cache is coupled to a bus that connects the non-volatile storage device and a controller corresponding to the non-volatile storage device.

32. The system of claim 25, wherein the non-volatile cache further serves as a cache for the non-volatile storage device.

33. The system of claim 25, further comprising an Option ROM to service requests to read data from the non-volatile storage device with data from the non-volatile cache, if requested data is readily available in the non-volatile cache, when the computing system resumes from the low power state.
